(19) United States
(12) Patent Application Publication
(10) Pub. No.: US 2007/0228124 A1
(43) Pub. Date: Oct. 4, 2007

(54) Folding boxes

(75) Inventors: Alfons Plescher, Wollersdorf (AT); Martina Maurer, Wien (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Baxter International, Inc., Deerfield, IL (US); Baxter Healthcare S.A., Wallisellen (CH)

(21) Appl. No.: 11/493,356

(22) Filed: Jul. 25, 2006

(30) Foreign Application Priority Data
Apr. 3, 2006 (DE) 20 2006 005 335.2

(51) Int. Cl. B31B 1/26

(52) U.S. Cl. 229/120.01

(57) ABSTRACT

The invention relates to a folding box and to a set of drugs having a folding box. The folding box of the invention is easy to produce, easy to handle, and allows the set of components to be kept separate from one another.

### CROSS-REFERENCES TO RELATED APPLICATIONS

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

1. Field of the Invention

The invention relates to a folding box and to a set of drugs having a folding box.

Various products, including medicines in particular, are sold in packets. These packets are often produced as folding boxes that are first printed from one or more strips of cardboard and then folded together. The products in question are then inserted into the folding boxes so that they can be safely stored therein, are easy to stack and are well presented when sold as a result of the printed exterior. Sometimes, products consisting of a number of components are also sold in folding boxes of this kind. It may be desirable in this case for the products of this kind to be separated from one another in the folding box in order to prevent individual components from banging against one another in the folding box.

2. Problem

The problem underlying the present invention is therefore to provide a folding box and a set of drugs that has set components and a folding box, which is easy to produce, which has an attractive exterior, and in which the set components can be kept separate from one another and are easy to handle.

3. Solution to the Problem

The problem is solved by the devices according to the independent claims. Advantageous embodiments are disclosed in the subclaims.

One aspect of the invention relates to a folding box that has a first container part and a second container part, the first container part having first container walls and the second container part having second container walls, the first container walls forming a first container interior and the second container walls forming a second container interior physically separated from the first container interior, and the first container part being releasably connected to the second container part by means of a connecting element. The two container interiors separated from one another ensure that products that are to be kept in the container interiors can be kept separate from one another in order to prevent the objects from banging against each other. This is particularly advantageous if, for example, two different glass containers are to be kept in the container interiors. Such a folding box also has the advantage that the two container parts can easily be separated from one another without tools so that, for example, one of the container parts can be kept separate from the other. At the same time, it is ensured that the two container parts can be sold joined together. This guarantees that the products that are stored in the two container parts can only be sold together.

In a folding box of this kind, at least a first side wall of the first container walls and a second side wall of the second container walls are preferably formed from a single-piece wall and the connecting element is formed from a perforation of the single-piece wall. A preferred folding box of this kind has the advantage that a corresponding single-piece wall, which, for example, can be made from a piece of cardboard and has a perforation, is easy to produce. A connecting element of this kind can also be torn apart along the perforation so that the two container parts that are connected to one another by a connecting element of this kind can easily be separated from one another. However, other ways of weakening the single-piece wall are also conceivable, for example by scratching, the scratching not going right through the material at the corresponding points. The single-piece wall can be formed from parts of the container walls or attached to areas of the container walls, for example by adhesive bonding.

Also advantageous is a folding box whose layout is essentially formed from a continuous single-piece wall perforated along the connecting element. A particularly preferred folding box of this kind can be made from a single piece, preferably from a single piece of cardboard. This single-piece wall can then be printed on one or both sides, perforated and folded together. In this way, a folding box with two container parts which can easily be separated from one another by tearing along a perforation can be made from a single piece of cardboard.

A further advantageous embodiment relates to a folding box, the perforation of the connecting element running along a straight line in the layout. A perforation along a straight line has the advantage that it is particularly easy to produce.

In a preferred folding box, the perforation of the connecting element is formed, when the folding box is folded, from at least two areas that do not run along a straight line. A perforation which is formed from at least two areas when the folding box is folded has the advantage that, through two areas of this kind, the two container parts can be permanently connected to one another without one container part being able to fold along an area of this kind that would then act like a hinge. A perforation of this kind in the layout can preferably run in a straight line here, one or more of the folded edges cutting across the straight line at an angle so that at least two areas of the perforation when folded run in two or more straight lines.

It is also advantageous if, in a folding box, the at least two areas run at least in each case partly along two shared edges of the first container part and the second container part. If the two edges run along two shared edges of the first and the second container parts, this has the advantage that the two container parts each have the tear-off edge in the area of their edges so that the two container parts do not have any parts sticking out when separated, as would be the case if the two areas were to run at least partly in an internal area of the side surfaces.

A folding box is also preferable in that the two edges are perpendicular to one another. The two edges that are perpendicular to one another have the advantage that it is possible to fix the two container parts firmly to one another, even if only two perforated edges are provided. The folding of a container part is prevented. The container parts in a folding box of this kind can also easily be separated from one another.

Also preferable is a folding box in which, when the two container parts are not separated, the connecting element runs in each case at least partly along three shared edges of the first container part and of the second container part. If the connecting element is provided in the area of three shared edges, an even more stable connection can thereby be produced.

Also advantageous is a folding box in which, when the two container parts are not separated, the connecting element runs in each case at least partly along four shared edges of the first container part and of the second container part. If the connecting element is provided along four shared edges, an even more stable connection is produced.

Particularly advantageous is a folding box in which, when the folding box is folded together but not separated, a ninth side wall and a tenth side wall come to rest at least partly against one another and at least one of the side walls in this area where they rest against one another has a printed area. A printed area on the side walls which rest against one another when connected together has the advantage that this external area of the container parts can also display information. An area of this kind preferably does not display any information which, at the time the product is being sold, contains details which are of interest to the sales staff or a potential customer in relation to his purchase decision. The use of the terms “ninth” side wall and “tenth” side wall is chosen in this context in order to be able to ascribe clear terms to the individual elements in the application description. The choice of terms should not be taken to mean that a folding box has ten or more side walls.

It is also preferred if, in a folding box, the printed area is prepared so that information can be added to it by hand, in particular references to certain dates, which are to be entered by hand in areas provided for this purpose. It is precisely areas of this kind, in which information is to be added by hand, that are usually of no interest in the selling process, so although the corresponding areas can usefully be used, they do not take up any space on the container surface that displays information that is important for the sale.

A further aspect of the invention relates to a set of drugs that has a first set component, a second set component and a folding box according to one of the advantageous aspects shown above, the first set component being kept in the first container interior and the second set component being kept in the second container interior. A set of drugs of this kind has the advantage that the two set components in the folding box can be kept separate from one another so that they do not bang against one another during transportation. A set of drugs of this kind also has the advantage that the two container parts can be separated from one another so that the two set components in the respective container parts can be kept in different places.

A set of drugs is preferred in which the first set component is designed so that the shelf life of the first set component is extended by cooling to below room temperature, preferably in a temperature range between about 0° C. and 10° C. A set of drugs of this kind has particular advantages if one of the set components is to be cooled because it is possible in this case to keep the set component to be cooled in a fridge in a space-saving manner while the other part can be kept somewhere else.

It is also advantageous if, in a set of drugs, the second set component is designed so that cooling of the second set component does not significantly improve its shelf life. A further advantage exists, if the second set component is not to be cooled, so that the first set component can be kept in the fridge and the second set component somewhere where environmental conditions are less restrictive.

### BRIEF SUMMARY OF THE INVENTION

### BRIEF DESCRIPTION OF THE DRAWINGS

FIG. 1a shows the layout of a preferred folding box according to the invention.

FIG. 1b shows the preferred folding box from FIG. 1a when partly folded together in a view that is perpendicular to the view shown in FIG. 1a.

FIG. 2a shows a layout of a second embodiment of a folding box.

FIG. 2b shows a folding box from FIG. 2a when partly folded together, the view being essentially perpendicular to the view shown in FIG. 2a.

FIG. 3 shows a layout of a third embodiment of a folding box.

### DETAILED DESCRIPTION OF THE INVENTION

Individual particularly preferred embodiments of the invention are described below. Some of the individually described embodiments have features that are not absolutely necessary to carry out the present invention but are generally regarded as being preferable. Embodiments are therefore to be regarded as falling within the teaching of the invention even if they do not contain all of the features of the embodiments described below. Equally, it is conceivable for features that are described with reference to different embodiments to be combined selectively with one another.

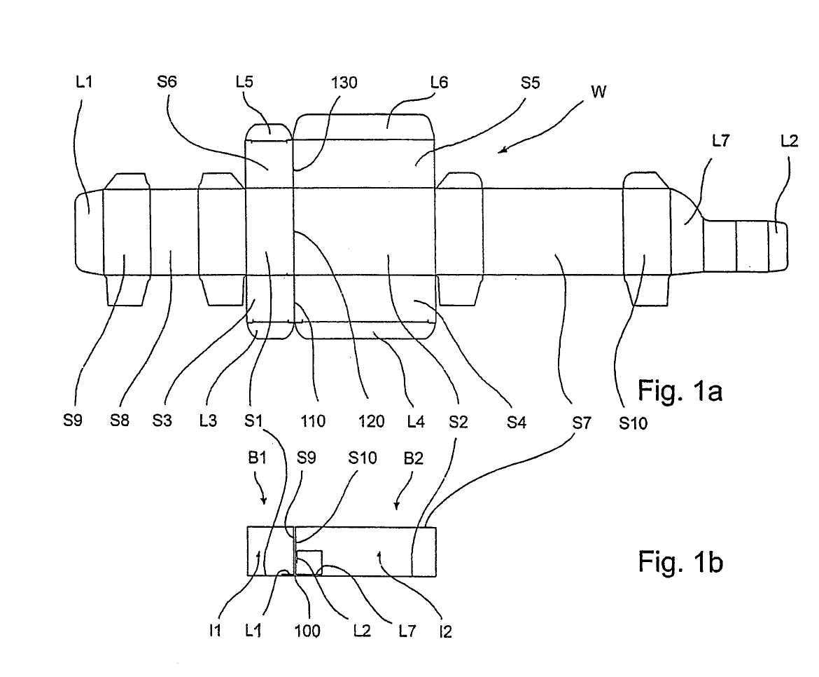

FIGS. 1a and 1b show a preferred embodiment of a folding box according to the invention. FIG. 1a shows a layout of the folding box in which a single-piece wall W with an outline is shown which is essentially shown by a continuous line. The broken lines within the outline indicate folding areas of the folding box along which the single-piece wall can be folded if the folding box is put together. Individual tabs, which are shown in the edge area of the single-piece wall, are preferably adhesively bonded to corresponding side walls when folded. This applies, for example, to a first tab L1 and a second tab L2, which, in FIG. 1a, are arranged on the far left and the far right of the elongate strip that shows part of the single-piece wall. When folded, tab L1 comes to rest on a first side wall S1 and is adhesively bonded there while tab L2 comes to rest on a second side wall S2 and is adhesively bonded there, as shown in FIG. 1b.

FIG. 1b shows the folding box when partly folded together whereby the elongate areas of the strip-shaped single-piece wall W are folded together in a spiral. The view of the folding box in FIG. 1b corresponds to a view in FIG. 1a looking from the bottom upwards. FIG. 1b shows a connecting element with the reference number 100. The connecting element 100 in the embodiment shown is formed by a perforation along a straight line of the single-piece wall W. FIG. 1a shows the connecting element 100 from areas 110, 120 and 130. In a particularly preferred embodiment, the perforation is only made in the areas 110 and 120, 110 and 130 or 120 and 130. When the folding box is folded together, these two areas correspond to two edges of two container parts B1 and B2, the edges being perpendicular to one another or running parallel at a distance from one another. In this way, the two container parts B1 and B2 are connected to one another and cannot fold back about an axis running through one of the edges. On the other hand, this preferred embodiment ensures that the two container parts can be separated from one another by tearing. When separated, the folding box is divided into two separate container parts B1 and B2, each constituting an essentially closed folded box.

Being essentially closed in this sense means that the container interiors are closed off from an external area around the container by the container walls so that the contents cannot fall out of the container and the influence of environmental effects on the contents is reduced. A hermetic seal is not usually necessary and this is not achieved in the preferred folding boxes either because the folding boxes can only be closed by lids that have tabs that are inserted into the container interior when the folding box is closed and which therefore make any unintentional opening of the boxes more difficult. A container of this kind can also have viewing windows depending on the design.

In the partly folded arrangement shown, in which the elongate areas of the single-piece wall are folded in a spiral, the lid and the floor areas of the finished folding box are still unfolded. The lid and floor areas in FIG. 1 are formed from a third, fourth, fifth and sixth side wall S3, S4, S5 and S6 with a third, fourth, fifth and sixth tab L3, L4, L5 and L6, which are each arranged at the ends of the side walls S3, S4, S5 and S6. When fully folded, these lid and floor areas are each folded in and the tabs L3, L4, L5 and L6 are inserted into the container interiors in order to fix the lid and floor areas in this position.

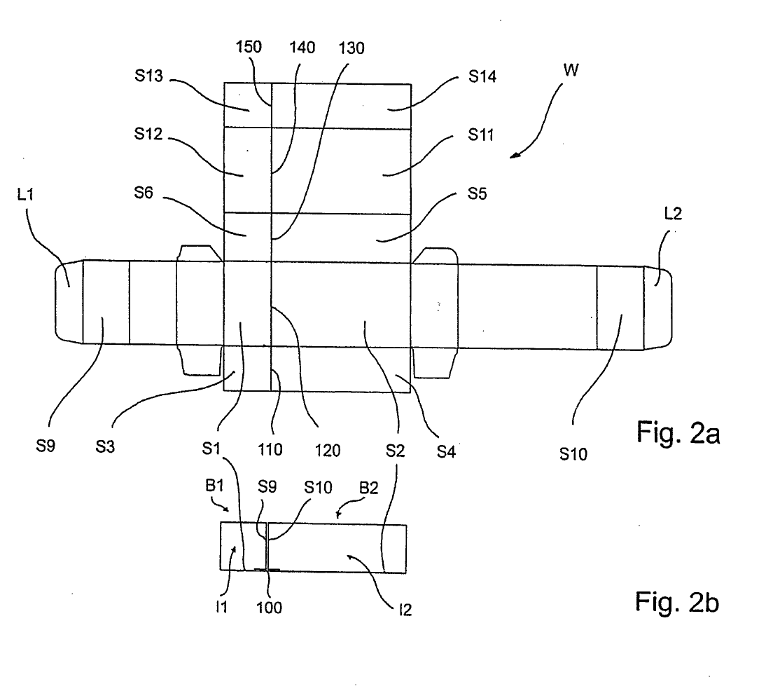

As shown in FIG. 1b, when fully folded, a first tab L1 and a second tab L2 which, when folded, come to rest against the side walls S1 and S10 respectively are adhesively bonded to the side walls S1 and S10. The tab area L7 is also adhesively bonded to the side wall S2. Through this further spiral layout, which is formed by the area between the tabs L7 and L2, an optional further insertion area is created in the second interior I2 of the second container part B2 in which, for example, a small bottle of drugs can be inserted in order to prevent this from sliding back and forth in the container interior of the second container part B2, for example during transportation. This insertion area can also be left unused, for example if larger bottles of drugs are to be put in the second container part B2 which essentially fill the second container interior I2, or if the second container interior is to be filled with other items where the items would prevent the undesired movement of one another. An embodiment in which no insertion area is provided is described, for example, in respect of the second embodiment shown in FIGS. 2a and 2b. Conversely, a similar insertion area can also be provided in this second embodiment if desired.

The material from which a folding box of this kind can be produced is preferably cardboard or a cellulose-containing material. However, depending on the area of use, it is also possible to use other materials such as thin plastic film, coated cardboard, hybrid materials, fiber-reinforced materials or the like. The single-piece wall W can be printed on one or both sides. When folded, a folding box is preferably correspondingly arranged and printed on all external surfaces with information on the products inside. Information that is not necessary for the sale of a folding box of this kind with the corresponding products, but which might be useful in later handling, is preferably printed on the side walls of the folding box that come to rest against each other when folded. In the embodiment shown, these are a ninth side wall S9 and a tenth side wall S10. This ensures that the surfaces that are on the outside when folded can have information printed on them that is useful for selling. Information that is preferably printed on the ninth and/or tenth side wall S9, S10 may, for example, be information that is intended to be added by hand, for example the date on which one of the container parts was put in the fridge.

In the preferred embodiment shown, the entire folding box is folded together from one single-piece wall. It is also conceivable for two container parts that have been produced separately from one another to be adhesively bonded to a single-piece wall that is bent into an L-shape and has a perforation along two or more of the shared edges of the container parts resting against one another. This embodiment is not shown in the figures.

The second embodiment shown in FIGS. 2a and 2b corresponds in many respects to the first embodiment described. To avoid repetition, essentially only the differences are described below.

The connecting element is also designated by the reference 100 in this second embodiment. As can be seen in FIG. 2a, this connecting element extends over areas that extend in a straight line along part areas 110, 120, 130, 140 and 150. Depending on the desired strength with which the two container parts are to be attached to one another, the perforation can be made in part areas of the respective areas, while other part areas are completely cut through. A perforation is preferably only made in either the fifth area 150 or the first area 110, while in the other area the material of the single-piece wall W is completely cut through because these two areas come to rest one above the other when folded.

In the embodiment shown, the elongate areas extending from left to right in FIG. 2a are folded together in a spiral. The tabs L1 and L2 are in this case not adhesively bonded to the side walls on which they rest when folded together. The areas extending from top to bottom in FIG. 2a are then folded around the elongate areas rolled up in a spiral shown in FIG. 2b. Finally, the third and fourth side surfaces S3, S4 are each adhesively bonded to the thirteenth and fourteenth side surfaces S13 and S14 respectively. According to this preferred embodiment, the fully assembled folding box does not have any external areas that can be opened without damaging the folding box. Only when the two container parts are torn apart along the perforation can the respective container parts be opened and closed again by their lid which is formed by the side surfaces S9 and S10.

This second embodiment has the advantage that a buyer can immediately see that the folding box he is buying has not already been opened. On the other hand, the first embodiment has the advantage that the folding boxes are produced separately and can be filled with the corresponding products somewhere else. On the other hand, in the second embodiment, the products have to be inserted during production of the folding box.

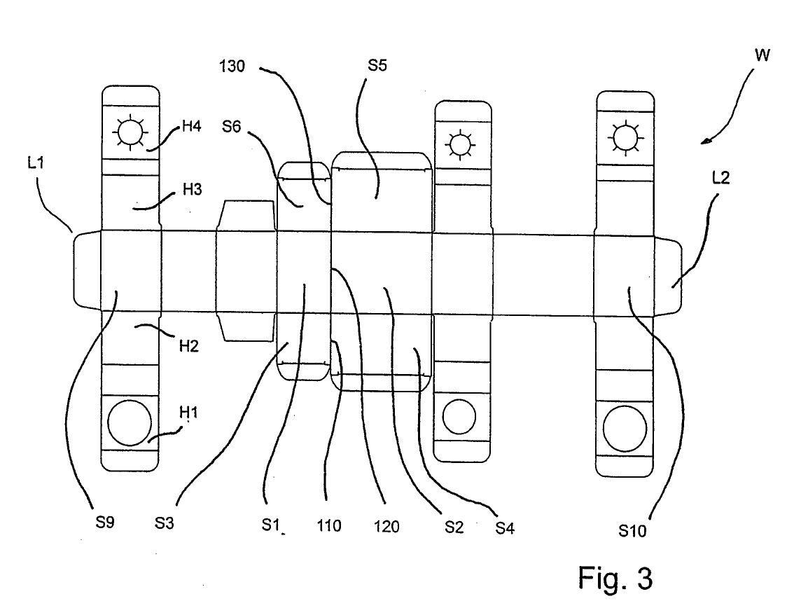

FIG. 3 shows a third embodiment of the folding box. This embodiment essentially corresponds to the embodiment shown in FIGS. 1a and 1b. Differences include the fact that, instead of the further spiral layout which is formed in the first embodiment by the area between the tabs L7 and L2 and is provided to create an optional further insertion area in the second interior I2 of the second container part B2, three holding areas are provided which each have two holding tabs. One of the holding areas is provided in the first container interior I1. The other two holding areas are provided in the second container interior I2.

The two holding tabs of a holding area each extend when laid out essentially perpendicularly to the central part of the folding box formed, inter alia, from the side walls S1, S2, S9 and S10. The holding tabs each have a stamped-through holding tab area H1, H4 in which, for example, a bottle of drugs can be inserted. The holding tabs are folded in for this purpose so that the respective stamped-through holding tab area H1, H4 is preferably arranged essentially perpendicularly to the side wall S9, S10, from which the respective holding tab extends, and comes to rest in the direction of the respective container interior parallel and at a distance from a further holding tab area H2, H3 of the holding tab.

As preferably two stamped-through holding tab areas H1, H4 are provided per bottle, it being possible for the stamped-through areas to be adjusted to different diameters and/or cross-sectional shapes of the bottles or items to be held, the bottle is fixed on both sides in the container interior.

In this way, for example, a bottle can be held, when the folding box is folded, in the stamped-through holding tab areas of the side walls of the folding box so that the latter cannot move relative to the side walls in the respective container interior. This prevents the bottle from being able to slide back and forth and stops it banging against the container walls.

In the third embodiment, three holding areas of the kind described are provided. It is also conceivable for only two or only one holding area of this kind to be provided and/or for another insertion area like the one described in relation to the embodiment shown in FIGS. 1a and 1b to be provided.

Another aspect of the invention relates to a set of drugs which is not shown in the figures and which preferably consists of at least two set components, one of which is intended to be stored in cool conditions in order to achieve a corresponding shelf life. The two set components are inserted into the two container parts of one of the folding boxes described above. The buyer of a set of drugs of this kind can then separate the two container parts from one another for storage and keep one container part in a fridge in a space-saving manner while the second container part together with the second set component can be kept somewhere else. In this way, for example, space in a fridge, which is usually limited, can be used sparingly.

What is claimed is:

1. A folding box that has a first container part (B1) and a second container part (B2), the first container part having first container walls and the second container part having second container walls, the first container walls forming a first container interior (I1) and the second container walls forming a second container interior (I2) physically separated from the first container interior, and the first container part being releasably connected to the second container part by means of a connecting element (100).

2. The folding box as claimed in claim 1, wherein at least a first side wall (S1) of the first container walls and a second side wall (S2) of the second container walls are formed from a single-piece wall (W) and the connecting element (100) is formed from a perforation of the single-piece wall (W).

3. The folding box as claimed in one of the preceding claims, wherein a layout of the folding box is essentially formed from a continuous single-piece wall (W) perforated along the connecting element.

4. The folding box as claimed in one of the preceding claims, wherein the perforation of the connecting element (100) runs along a straight line in the layout.

5. The folding box as claimed in one of the preceding claims, wherein the perforation of the connecting element is formed, when the folding box is folded, from at least two areas (110, 120; 120, 130; 120, 140) that do not run along a straight line.

6. The folding box as claimed in claim 5, wherein the at least two areas (110, 120; 120, 130; 120, 140) run at least in each case partly along two shared edges of the first container part and the second container part.

7. The folding box as claimed in claim 6, wherein the two edges are perpendicular to one another.

8. The folding box as claimed in one of the preceding claims, wherein, when the two container parts (B1, B2) are not separated, the connecting element (100) runs in each case at least partly along three shared edges of the first container part (B1) and of the second container part (B2).

9. The folding box as claimed in one of the preceding claims, wherein, when the two container parts (B1, B2) are not separated, the connecting element (100) runs in each case at least partly along four shared edges of the first container part (B1) and of the second container part (B2).

10. The folding box as claimed in one of the preceding claims, wherein, when the folding box is folded together but not separated, a ninth side wall (S9) and a tenth side wall (S10) come to rest at least partly against one another and at least one of the side walls in this area where they rest against one another has a printed area.

11. The folding box as claimed in claim 10, wherein the printed area is prepared so that information can be added to it by hand, in particular references to certain dates, which are to be entered by hand in areas provided for this purpose.

12. A set of drugs that has a first set component, a second set component and a folding box as claimed in one of claims 1 to 11, the first set component being kept in the first container interior (B1) and the second set component being kept in the second container interior (B2).

13. The set of drugs as claimed in claim 12, wherein the first set component is designed so that the shelf life of the first set component is extended by cooling to below room temperature, preferably in a temperature range between about 0° C. and 10° C.

14. The set of drugs as claimed in claim 12 or 13, wherein the second set component is designed so that cooling of the second set component does not significantly improve its shelf life.
